(19) United States
(12) Patent Application Publication
(10) Pub. No.: US 2026/0281664 A1
(43) Pub. Date: Sep. 17, 2026

(54) USER EQUIPMENT AND METHOD EXECUTED BY USER EQUIPMENT

(71) Applicant: Sharp Kabushiki Kaisha, Sakai City, Osaka (JP)

(72) Inventors: Fangying XIAO, Shanghai (CN); Renmao LIU, Shanghai (CN)

(21) Appl. No.: 19/166,310

(22) PCT Filed: Mar. 21, 2024
(86) PCT No.: PCT/CN2024/083036

§ 371 Date: Sep. 17, 2025

(30) Foreign Application Priority Data
Mar. 23, 2023 (CN) 202310293691.8

(51) Int. Cl. H04W 4/06; H04W 76/27

(52) U.S. Cl. CPC H04W 4/06; H04W 76/27

(57) ABSTRACT

Provided in the present disclosure are a user equipment and a method executed by a user equipment. The user equipment (UE) includes a processor configured to: receive an RRC release message, wherein the RRC release message is used to configure, by including configuration information of an MBS multicast session, the MBS multicast session to be received by the UE in RRC_INACTIVE; and indicate a mapping between a TMGI and a G-RNTI for the MBS multicast session in the RRC release message.

### TECHNICAL FIELD

The present invention relates to the technical field of wireless communications. More specifically, the present invention relates to a method executed by a user equipment, and a user equipment.

### BACKGROUND ART

A study item (SI) on architectural enhancements for 5G multicast-broadcast services (see SP-190625 for details) has been approved. One objective (referred to as Objective A) of this SI is to support general-purpose MBS services in 5GS, and use cases that can benefit from these characteristics include (but are not limited to) public safety, V2X applications, transparent IPv4/IPv6 multicast delivery, IPTV, wireless software delivery, group communications, Internet of Things applications, etc. Correspondingly, at the 3rd Generation Partnership Project (3GPP) RAN #86 plenary meeting, an NR multicast and broadcast service (NR MBS) work item was proposed (see Non-Patent Document: RP-193248: New Work Item on NR support of Multicast and Broadcast Services), and was approved. This work item aims to provide the support in the RAN for Objective A. The objective of the work item has substantially been achieved. For a detailed description of related solutions, see technical documents of 3GPP Release 17, such as TS 38.300-h30, TS 38.331-h30, TS 38.321-h30, etc. At the 3GPP RAN #94 plenary meeting, a work item named enhanced NR broadcast/multicast (see Non-Patent Document: RP-213568: New WID: Enhancements of NR Multicast and Broadcast Services) was approved. This work item aims to further enhance the MBS broadcast/multicast of Release 17, and one of its objectives is to support the user equipment in receiving MBS multicast services in RRC_INACTIVE.

The present invention discusses related issues involved in the RAN supporting the user equipment in receiving the MBS multicast services in RRC_INACTIVE.

### SUMMARY OF THE INVENTION

In order to address the aforementioned issue, the present invention provides a method executed by a user equipment, and a user equipment.

According to a first aspect of the present invention, a method executed by a user equipment (UE) is provided, comprising: step 1: receiving, by the UE, dedicated RRC signaling from a base station, wherein the dedicated RRC signaling comprises a mapping between a TMGI and a G-RNTI and/or a G-CS-RNTI; and step 2: indicating, by the UE to a lower layer, a G-RNTI and/or a G-CS-RNTI mapped to one or a plurality of TMGIs; or indicating, by the UE to a lower layer, a G-RNTI and/or a G-CS-RNTI corresponding to an MBS multicast session which is configured to be received in RRC_INACTIVE and is in an active state; or instructing, by the UE, a lower layer to receive an MBS multicast session which is configured to be received in RRC_INACTIVE and is in an active state.

In the method according to the first aspect, preferably, step 2 may be executed when the UE is configured with an MBS multicast session configured to be received in RRC_INACTIVE and/or when at least one MBS multicast session configured to be received in RRC_INACTIVE is activated.

In the method according to the first aspect, preferably, when the UE instructs a MAC entity to execute MAC partial reset, the MAC entity may execute at least one of the following operations: stopping monitoring a G-RNTI and/or a G-CS-RNTI and/or a C-RNTI that are/is not mapped to a TMGI; stopping timers except discontinuous reception (DRX) timers for MBS broadcast and MBS multicast which is configured to be received in RRC_INACTIVE and is activated; flushing a message 3 (Msg3) buffer; flushing an MSGA buffer; flushing buffers of all uplink HARQ processes; and setting NDIs of all the uplink HARQ processes to 0.

In the method according to the first aspect, preferably, the dedicated RRC signaling may be an RRC release message, and the mapping between a TMGI and a G-RNTI and/or a G-CS-RNTI may be defined in a suspendConfig field included in the RRC release message, or the mapping between a TMGI and a G-RNTI and/or a G-CS-RNTI may be defined in a RadioBearerConfig field comprised in the suspendConfig field included in the RRC release message, or the mapping between a TMGI and a G-RNTI and/or a G-CS-RNTI may be defined in a MAC-CellGroupConfig field comprised in the suspendConfig field included in the RRC release message.

In the method according to the first aspect, preferably, the UE may reset the MAC entity when the UE is not configured with an MBS multicast session configured to be received in RRC_INACTIVE or when none of MBS multicast sessions configured to be received in RRC_INACTIVE is activated.

In the method according to the first aspect, preferably, when the UE resets the MAC entity, the MAC entity executes at least one of the following operations: stopping all timers except a DRX timer for MBS broadcast; setting NDIs of all uplink HARQ processes to 0; stopping all ongoing random access; flushing a message 3 (Msg3) buffer; flushing an MSGA buffer; canceling a triggered scheduling request procedure; canceling a triggered buffer status reporting procedure; and canceling a triggered power headroom reporting procedure.

In the method according to the first aspect, preferably, the UE may reconfigure MAC main configurations of a corresponding cell group except tag-ToReleaseList and tag-ToAddModList on the basis of Mac-CellGroupConfig comprised in the received dedicated RRC signaling.

In the method according to the first aspect, preferably, when the UE in RRC_INACTIVE receives a paging message from the base station, and the paging message indicates that an MBS multicast session joined by the UE is activated, the UE may execute at least one of the following operation 1 and operation 2: operation 1: indicating the MBS multicast session to a MAC layer, or indicating to the MAC layer that the MBS multicast session is activated, or indicating a G-RNTI and/or a G-CS-RNTI corresponding to the activated MBS multicast session to the MAC layer, or instructing the MAC layer to start/continue receiving the MBS multicast session; and operation 2: resuming an MRB corresponding to the MBS multicast session.

In the method according to the first aspect, preferably, when the UE in RRC_INACTIVE receives a paging message from the base station, and the paging message indicates that an MBS multicast session joined by the UE is deactivated, the UE may execute at least one of the following operation 1 and operation 2: operation 1: indicating the MBS multicast session to a MAC layer, or indicating a G-RNTI corresponding to the deactivated MBS multicast session to the MAC layer, or indicating to the MAC layer that the MBS multicast session is deactivated, or instructing the MAC layer to stop receiving the MBS multicast session; and operation 2: suspending an MRB corresponding to the MBS multicast session.

In addition, according to a second aspect of the present invention, a user equipment is provided, comprising: a processor; and a memory storing instructions, wherein when run by the processor, the instructions execute the method described above.

### Beneficial Effect of the Present Invention

According to the present invention, a method executed by a user equipment (UE) for reducing unnecessary energy consumption of the user equipment in an MBS multicast session as well as a corresponding user equipment can be provided.

### BRIEF DESCRIPTION OF THE DRAWINGS

The above and other features of the present invention will be more apparent from the following detailed description in combination with the accompanying drawings, in which:

FIG. 1 is a flowchart schematically showing a method executed by a user equipment (UE) according to an embodiment of the present invention; and

FIG. 2 is a simplified structural block diagram showing a user equipment according to the present invention.

### DETAILED DESCRIPTION OF PREFERRED EMBODIMENTS

The following describes the present invention in detail with reference to the accompanying drawings and specific implementations. It should be noted that the present invention should not be limited to the specific implementations described below. In addition, detailed descriptions of well-known technologies not directly related to the present invention are omitted for the sake of brevity, in order to prevent obscuring the understanding of the present invention.

The following describes some terms involved in the present invention. For the specific meanings of the terms, see the latest 3GPP related documents, for example, TS38.300-h30, TS38.321-h30, TS38.323-h30, TS38.331-h30, etc. In addition, the embodiments of the present invention are described by using a broadcast/multicast service as an example, but the embodiments of the present invention are not limited to the broadcast/multicast service, and may also be applied to other application scenarios.
UE: User Equipment.
RRC: Radio Resource Control.
RRC_CONNECTED: RRC connected state.
RRC_INACTIVE: RRC inactive state.
RRC_IDLE: RRC idle state.
RAN: Radio Access Network.
NR: New RAT, New Radio Access Technology.
MBS: Multicast/Broadcast Services. Multicast may also be referred to as groupcast.
AS: Access Stratum
NAS: Non Access Stratum
RB: Radio Bearer. DRB: Data Radio Bearer.
MRB: MBS radio bearer, i.e., a radio bearer that is configured for MBS delivery. MRBs are classified into multicast MRBs, which are radio bearers configured for MBS multicast delivery, and broadcast MRBs, which are radio bearers configured for MBS broadcast delivery.
TMGI: Temporary Mobile Group Identity for identifying an MBS session.
RNTI: Radio Network Temporary Identifier.
PTM: Point to Multipoint, an MBS service delivery mode. In the PTM delivery mode, a base station (gNB) delivers a single copy of MBS data packets to a set of UEs. The UEs receives the PTM transmission using either a G-RNTI or a G-CS-RNTI. For example, the base station employs a group common physical downlink control channel (PDCCH) using a G-RNTI to schedule a group common physical downlink shared channel (PDSCH) using the same G-RNTI.
PTP: Point to Point, an MBS service delivery mode. In the PTP delivery mode, a RAN node (gNB) individually delivers separate copies of MBS data packets to each UE independently. For example, the base station use a UE dedicated PDSCH scrambled by a UE dedicated RNTI to schedule a UE dedicated PDCCH scrambled by the same UE dedicated RNTI.
G-RNTI: Group RNTI, which is used to scramble the scheduling and transmission of PTM for one or more MBS multicast services.
G-CS-RNTI: group configuration scheduling RNTI, which is used to scramble a semi-persistently scheduled (SPS) group common physical downlink shared channel (PDSCH) of one or more MBS multicast services and activate/deactivate the SPS group common PDSCH.

The RRC resume request message RRCResumeRequest or RRCResumeRequest1 is used to request the resumption of a suspended RRC connection or used to execute RAN-based notification area (RNA) updating. The RRC release message RRCRelease is used to command the release of an RRC connection or suspension of an RRC connection. The RRC reconfiguration message RRCReconfiguration is used to command modification of an RRC connection. The RRC resume message RRCResume is used to resume a suspended RRC connection.

In the present invention, a network, a base station, and a RAN may be used interchangeably. The network may be a Long Term Evolution (LTE) network, an NR network, an enhanced Long Term Evolution (eLTE) network, or another network defined in a subsequent evolved version of the 3GPP.

Currently, NR MBS services include MBS broadcast (also referred to as an MBS broadcast session, or broadcast MBS, or an MBS broadcast service) and MBS multicast (also referred to as an MBS multicast session, or multicast MBS, or an MBS multicast service). The MBS broadcast provides a downlink-only MBS delivery mode for a service with low quality of service (QoS), so that a UE in either RRC_CONNECTED, or RRC_IDLE, or RRC_INACTIVE can receive the MBS service. The UE acquires network-broadcast MBS broadcast configuration information by means of an MBS control channel (MCCH). In 3GPP Release 17, the UE, before receiving the MBS multicast service, needs to set up an RRC connection with a base station, and then the base station performs configuration for the UE by means of dedicated RRC signaling (also referred to as an RRC message, such as an RRC reconfiguration message). Moreover, MBS radio bearers (MRBs) receiving these MBS multicast services or MBS multicast sessions may also be configured for the UE by the base station by means of dedicated RRC signaling. Only the UE that is in RRC_CONNECTED and is configured with the MRB can receive a corresponding MBS multicast service.

When an MBS multicast session is activated by a core network, or a base station has MBS multicast session data to be sent, a network supporting the MBS multicast notifies the UE that is in RRC_IDLE or RRC_INACTIVE by means of a group notification mechanism. Upon receiving the group notification, the UE which is interested in the MBS multicast session sets up an RRC connection with the network to receive the corresponding MBS multicast session. The group notification is addressed with P-RNTI on PDCCH, and the UE monitors a paging channel. A paging message for the group notification includes an MBS session identity TMGI and is used to page all UEs that have joined the relevant MBS multicast session and are in RRC_IDLE or RRC_INACTIVE. In other words, the base station does not page the UEs individually.

For an MBS multicast session configured to be received in RRC_INACTIVE, the base station may provide corresponding PTM configuration information (also referred to as MBS multicast configuration information) for receiving the MBS multicast session to the UE by means of dedicated RRC signaling or by means of an MBS control channel (MCCH). MCCH configuration information (i.e., information required for acquiring MCCH configurations (or MCCH information) of MBS multicast) may be configured for the UE by means of dedicated RRC signaling or a system information block (denoted as SIBx). In other words, SIBx includes the information required for acquiring the MCCH configurations (or MCCH information) of MBS multicast. The PTM configuration information may include an MRB-ToAddMod field for configuration information of an MRB corresponding to the MBS multicast session, and/or an MBS-RNTI-SpedificConfig field for configuring configuration information such as a G-RNTI/G-CS-RNTI and DRX corresponding to the MBS multicast session, etc. The MBS-RNTI-SpedificConfig field is included in a Mac-CellGroupConfig field.

Each MBS multicast session is identified by one TMGI and is associated with one G-RNTI (i.e., the UE receives the MBS multicast session by monitoring a corresponding G-RNTI). For MBS multicast, a MAC entity may be configured by RRC with a discontinuous reception (DRX) functionality per G-RNTI or per G-CS-RNTI that controls the UE's PDCCH monitoring activity for the MAC entity's G-RNTI(s) and/or G-CS-RNTI(s).

In Release 17, only a UE in RRC_CONNECTED can receive an MBS multicast session, and a correspondence/mapping between a TMGI and a G-RNTI and/or a G-CS-RNTI for the MBS multicast session is invisible to the UE in RRC_CONNECTED, i.e., the base station does not need to configure a direct mapping between a TMGI and a G-RNTI and/or a G-CS-RNTI for the UE in RRC_CONNECTED. The UE monitors all G-RNTIs and/or G-CS-RNTIs configured by the base station for the UE. In Release 18, a UE in RRC_INACTIVE is allowed to receive an MBS multicast session. However, only an MBS multicast session configured to be received in RRC_INACTIVE can be received by the UE in RRC_INACTIVE. The base station may include an indication or configure an MRB or a TMGI in dedicated RRC signaling (e.g., an RRC release message) to specify an MBS to be received in RRC_INACTIVE. If only some MBS multicast sessions are configured to be received in RRC_INACTIVE, the other MBS multicast sessions that are not configured to be received in RRC_INACTIVE (i.e., that can be received only in RRC_CONNECTED) are suspended when the UE enters RRC_INACTIVE. Because the mapping between a TMGI and a G-RNTI and/or a G-CS-RNTI is invisible to the UE, when the UE is in RRC_INACTIVE, the UE cannot determine a G-RNTI and/or a G-CS-RNTI corresponding to an MBS multicast session configured to be received in RRC_INACTIVE. A discontinuous reception (DRX) functionality is configured separately for each G-RNTI and/or G-CS-RNTI. If the UE monitors all of the G-RNTIs or G-CS-RNTIs configured by the base station for the UE when the UE enters RRC_INACTIVE, unnecessary energy consumption will be caused.

In this regard, the present disclosure provides corresponding embodiments to solve at least some of the above problems. Specific embodiments are provided below to describe a processing method of the present invention. In addition, the following embodiments listed are merely examples rather than limitations on the present invention.

### Embodiments

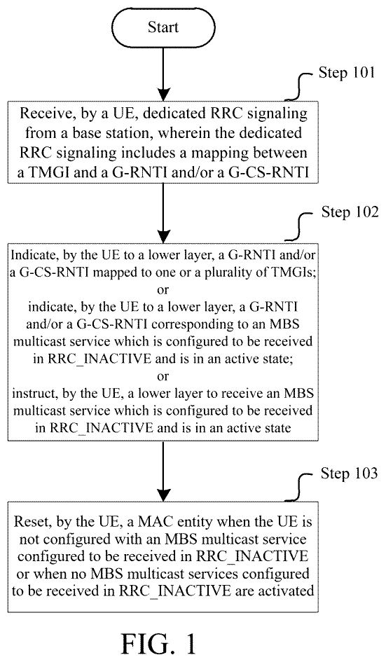

Embodiments of the present disclosure will be described in detail below. FIG. 1 is a flowchart schematically showing a method executed by a user equipment (UE) according to an embodiment of the present invention. As shown in FIG. 1, in the present embodiment, the following steps may be included:
Step 101: receiving, by a UE, a dedicated RRC signaling (i.e., an RRC message) from a base station, wherein the dedicated RRC signaling includes a mapping between a TMGI and a G-RNTI and/or a G-CS-RNTI. The dedicated RRC signaling may be an RRC release message or an RRC reconfiguration message.

Optionally, it may be specified that only when the dedicated RRC signaling received by the UE from the base station in step 101 includes a suspendConfig field used to indicate RRC_INACTIVE configuration, the UE can further determine whether the suspendConfig field includes a field used to define the mapping between a TMGI and a G-RNTI and/or a G-CS-RNTI.
Step 102: executing, by the UE, the following operation if the UE is configured with an MBS multicast session to be received in RRC_INACTIVE and/or at least one MBS multicast session configured to be received in RRC_INACTIVE is activated (these two conditions are optional):

Preferably, indicating, by the UE to a lower layer (e.g., a MAC layer/entity), a G-RNTI and/or a G-CS-RNTI mapped to one or a plurality of TMGIs; or indicating, by the UE to a lower layer (e.g., a MAC layer/entity), a G-RNTI and/or a G-CS-RNTI corresponding to the MBS multicast session which is configured to be received in RRC_INACTIVE and is in an active state; or instructing, by the UE, a lower layer (e.g., MAC layer/entity) to receive the MBS multicast session which is configured to be received in RRC_INACTIVE and is in an active state.

Alternatively, the UE instructs the MAC entity to execute MAC partial reset.

Alternatively, MAC main configurations of a corresponding cell group except tag-ToReleaseList and tag-ToAddModList are reconfigured on the basis of Mac-CellGroupConfig included in the received dedicated RRC signaling. The Mac-CellGroupConfig field is used to configure MAC parameters (including DRX) of a cell group; and tag-ToReleaseList is used to indicate a list of released time alignment groups (TAGs), and tag-ToAddModList is used to indicate a list of added or modified TAGs.

Alternatively, the UE (that is, the RRC) instructs the MAC entity to stop monitoring a G-RNTI and/or a G-CS-RNTI and/or a C-RNTI that are/is not mapped to a TMGI. In other words, the UE instructs the MAC entity to stop monitoring a G-RNTI and/or a G-CS-RNTI and/or a C-RNTI that are/is not mapped to a TMGI.

Otherwise (i.e., neither an MBS multicast session which is not configured to be received in RRC_INACTIVE nor an MBS multicast session configured to be received in RRC_INACTIVE is activated), step 103 is executed.
Step 103: resetting the MAC entity.

It should be noted that the execution order of the steps listed in the above embodiment is not limited, and changing the execution order of determination conditions in steps 101 and 102 also falls within the scope of protection of the present disclosure. In step 102, the MBS multicast session to be received in RRC_INACTIVE may be configured for the UE and/or activated in the dedicated RRC signaling, or the MBS multicast session may be configured and/or activated in another RRC message different from the dedicated RRC signaling.

The mapping between a TMGI and a G-RNTI and/or a G-CS-RNTI included in the RRC signaling may be defined in the following manners:

Manner A: the dedicated RRC signaling is an RRC release message, and the mapping between a TMGI and a G-RNTI and/or a G-CS-RNTI is defined in the suspendConfig field included in the RRC release message. For example, a TMGI or a TMGI list associated with each G-RNTI is defined.

Manner B: the dedicated RRC signaling is an RRC release message, and the mapping between a TMGI and a G-RNTI and/or a G-CS-RNTI is defined in a RadioBearerConfig field included in the suspendConfig field included in the RRC release message. For example, to define a G-RNTI corresponding to each TMGI, a G-RNTI of each MBS multicast session may be included in the MRB-ToAddMod field used to configure an MRB for the MBS multicast session. The MRB-ToAddMod field includes PDCP configuration information, an MRB identifier, etc., corresponding to the MRB for the MBS multicast session.

Manner C: the dedicated RRC signaling is an RRC release message, and the mapping between a TMGI and a G-RNTI and/or a G-CS-RNTI is defined in MAC-14 CellGroupConfig included in the suspendConfig field included in the RRC release message. For example, a TMGI or a TMGI list associated with each G-RNTI is defined.

The suspendConfig field is used to indicate an RRC_INACTIVE configuration; and the RadioBearerConfig field is used to add, modify, or release a signaling radio bearer, a multicast MRB, and/or a data radio bearer, and a PDCP parameter is included.

The UE may determine, in one of the following manners, whether the UE is configured with an MBS multicast session to be received in RRC_INACTIVE or whether an MBS multicast session configured to be received in RRC_INACTIVE is activated:

Manner I: the dedicated RRC signaling is an RRC release message, and the message includes PTM configuration information (implicitly indicating that the MBS multicast session is activated) corresponding to the MBS multicast session.

Manner II: the dedicated RRC signaling defines the mapping between a TMGI and a G-RNTI and/or a G-CS-RNTI (implicit indication). The MBS multicast session corresponding to the TMGI mapped to the G-RNTI is activated.

Manner III: for an MBS multicast session that is being received by a UE in RRC_CONNECTED or an MBS multicast session whose corresponding MRB is configured by an RRC reconfiguration message, if the RRC release message received by the UE does not indicate deactivation of the MBS multicast session, it indicates that the MBS multicast session is in activated state after the UE enters RRC_INACTIVE in response to receiving the RRC release message; or on the contrary, if the RRC release message received by the UE indicates that the MBS multicast session is deactivated, it indicates that the MBS multicast session is in a deactivated state after the UE enters RRC_INACTIVE in response to receiving the RRC release message.

Manner IV: if the RRC release message received by the UE includes configuration information of an MBS multicast session, for example, a configuration of an MRB or a configuration of a corresponding G-RNTI or G-CS-RNTI, it indicates that the MBS multicast session is activated, or otherwise is deactivated.

In addition, the base station may include an indication (denoted as a MulticastInInactiveIsAllowed field) in the dedicated RRC signaling (e.g., an RRC release message or an RRC reconfiguration message) to indicate whether the UE is allowed to receive an MBS multicast session in RRC_INACTIVE. When a MBS multicast session is activated, a UE configured to allow for reception of an MBS multicast session in RRC_INACTIVE checks whether PTM configuration information of the MBS multicast session is configured in received dedicated RRC signaling (e.g., an RRC release message) or an MCCH of MBS multicast. If the PTM configuration information of the MBS multicast session is configured in the received dedicated RRC signaling or the MCCH of MBS multicast, it indicates that the MBS multicast session is configured to be received in RRC_INACTIVE (i.e., the UE receives the MBS multicast session on the basis of the PTM configuration information), or otherwise it indicates that the MBS multicast session is not configured to be received in RRC_INACTIVE, and in this case, the UE needs to enter RRC_CONNECTED to receive the MBS multicast session. It may be specified that if the RRC release message includes the PTM configuration information of the MBS multicast session, the RRC release message has to include the MulticastInInactiveIsAllowed field and/or a value of the MulticastInInactiveIsAllowed field is set to true or “true”; and it may also be specified that if the RRC release message includes the PTM configuration information of the MBS multicast session, it indicates that the UE is configured to receive an MBS multicast session in RRC_INACTIVE, and in this case, the RRC release message does not include the MulticastInInactiveIsAllowed field.

The base station may also indicate, by using dedicated RRC signaling (e.g., an RRC release message or an RRC reconfiguration message), whether to allow for reception in RRC_INACTIVE for each MBS multicast session.

If the base station does not configure the mapping between a TMGI and a G-RNTI by means of the dedicated RRC signaling, when an MBS multicast session is deactivated, the UE reads MCCH information of the MBS multicast session (i.e., a message or information transmitted on an MCCH logical channel of the MBS multicast session). If a PTM configuration of an MBS multicast session configured to be received in RRC_INACTIVE is not included in the MCCH information, the UE suspends an MRB for the MBS multicast session and/or a MAC entity of the UE stops a DRX timer corresponding to the MBS multicast session or a G-RNTI thereof (i.e., stops all timers except discontinuous reception (DRX) timers for MBS broadcast or MBS multicast that is configured in the MCCH information or a G-RNTI thereof). Optionally, after determining that the MBS multicast session is deactivated, the RRC indicates related information to a lower layer (e.g., MAC), so that the MAC entity stops a DRX timer corresponding to the MBS multicast session or a G-RNTI thereof. When the MBS multicast session is activated, if the PTM configuration of the MBS multicast session configured to be received in RRC_INACTIVE is configured by means of dedicated RRC signaling or included in the MCCH information, a corresponding MRB is resumed and/or the MAC entity of the UE starts the DRX timer corresponding to the MBS multicast session or the G-RNTI thereof. Optionally, after determining that the MBS multicast session is activated, the RRC indicates related information to a lower layer (e.g., MAC), so that the MAC entity starts a DRX timer corresponding to the MBS multicast session or a G-RNTI thereof.

The base station may further associate each MBS multicast session with one indication in the dedicated RRC signaling transmitted to the UE, to indicate whether the corresponding MBS multicast session can be received in RRC_INACTIVE.

The PTM configuration information corresponding to the MBS multicast session includes at least a configuration of an MRB. The PTM configuration included in the dedicated RRC signaling may employ an incremental configuration manner.

### The Following Describes Operations Executed by the MAC Layer/Entity in Response to Receiving the Indication from an Upper Layer (RRC Layer/Entity).

If the UE (i.e., the RRC layer/entity) instructs the MAC entity to execute MAC partial reset, the MAC entity executes at least one of the following operations (i.e., operations executed for the MAC partial reset): stopping monitoring a G-RNTI and/or a G-CS-RNTI and a C-RNTI that are/is not mapped to a TMGI (i.e., monitors only a G-RNTI and/or a G-CS-RNTI that are/is mapped to a TMGI); stopping timers except discontinuous reception (DRX) timers for MBS broadcast and MBS multicast which is configured to be received in the inactive state and is activated; and/or flushing a message 3 (Msg3) buffer; and/or flushing an MSGA buffer; and/or flushing buffers of all uplink HARQ processes; and and/or setting NDIs of all the uplink HARQ processes to 0.

If the UE (i.e., the RRC layer/entity) instructs the MAC entity to execute MAC reset, the MAC entity executes at least one of the following operations (i.e., operations executed for the MAC reset): stopping all timers except a DRX timer for MBS broadcast; and/or setting NDIs of all uplink HARQ processes to 0; and/or stopping all ongoing random access; and/or flushing a message 3 (Msg3) buffer; and/or flushing an MSGA buffer; and/or canceling a triggered scheduling request procedure; and/or canceling a triggered buffer status reporting procedure; and and/or canceling a triggered power headroom reporting procedure.

If the UE instructs the MAC entity to stop monitoring a G-RNTI and/or a G-CS-RNTI and/or a C-RNTI that are/is not mapped to a TMGI, the MAC entity stops monitoring the G-RNTI and/or the G-CS-RNTI and/or a C-RNTI that are/is not mapped to a TMGI (i.e., the MAC entity monitors only a G-RNTI and/or a G-CS-RNTI that are/is mapped to a TMGI and that are/is indicated/configured by an upper layer).

### Operations Executed by the UE when a Deactivated MBS Multicast Session is Received in a Paging Message.

When the UE in RRC_INACTIVE receives a paging message from the base station, if the paging message indicates that an MBS multicast session joined by the UE is deactivated, at least one of the following operations 1-1 and 1-2 is executed:
Operation 1-1: indicating the MBS multicast session to a MAC layer, or indicating a G-RNTI corresponding to the deactivated MBS multicast session to the MAC layer, or indicating to the MAC layer that the MBS multicast session is deactivated, or instructing the MAC layer to stop receiving the MBS multicast session; and
Operation 1-2: suspending an MRB corresponding to the MBS multicast session.

The condition “if the paging message indicates that an MBS multicast session joined by the UE is deactivated” may be replaced with “if the paging message indicates that an MBS multicast session joined by the UE and configured to be received in RRC_INACTIVE is deactivated”; or may be replaced with “if the paging message indicates that an MBS multicast session joined by the UE and configured to be received in RRC_INACTIVE is deactivated and a PTM configuration of the MBS multicast session is configured for the UE by means of dedicated RRC signaling”.

After receiving the indication from the upper layer (i.e., the RRC layer/entity), the MAC entity stops a DRX timer for the MBS multicast session and/or stops monitoring a G-RNTI and/or a G-CS-RNTI corresponding to the MBS multicast session.

When the UE in RRC_INACTIVE receives a paging message from the base station, if the paging message indicates that an MBS multicast session joined by the UE is activated, at least one of the following operations 2-1 and 2-2 is executed:
Operation 2-1: indicating the MBS multicast session to a MAC layer, or indicating to the MAC layer that the MBS multicast session is activated, or indicating a G-RNTI and/or a G-CS-RNTI corresponding to the activated MBS multicast session to the MAC layer, or instructing the MAC layer to start/continue receiving the MBS multicast session; and
Operation 2-2: resuming an MRB corresponding to the MBS multicast session.

The condition “if the paging message indicates that an MBS multicast session joined by the UE is activated” may be replaced with “if the paging message indicates that an MBS multicast session joined by the UE and configured to be received in RRC_INACTIVE is activated”; or may be replaced with “if the paging message indicates that an MBS multicast session joined by the UE and configured to be received in RRC_INACTIVE is activated and a PTM configuration of the MBS multicast session is configured for the UE by means of dedicated RRC signaling”.

After receiving the indication from the upper layer (i.e., the RRC layer/entity), the MAC entity starts or continues monitoring a G-RNTI and/or a G-CS-RNTI corresponding to the MBS multicast session, and/or starts a DRX timer of the MBS multicast session.

In addition to activating/deactivating an MBS multicast session by means of a paging message, the base station may further perform indication in a message transmitted on an MCCH for multicast MBS, or may employ a MAC control element (MAC CE) that includes a G-RNTI or a TMGI or a bitmap of an activated or a deactivated MBS multicast session. If a bitmap is used, bits in the bitmap correspond one-to-one to MBS multicast sessions configured to be received in the inactive state through dedicated RRC signaling or correspond one-to-one to activated MBS multicast sessions configured to be received in the inactive state through dedicated RRC signaling.

If the base station indicates, in the message transmitted on the MCCH of multicast MBS, that the MBS multicast session is activated or deactivated, the UE executes the operations executed when receiving the paging message for activating or deactivating the MBS multicast session.

If the base station employs a MAC CE to notify the UE that the MBS multicast session is activated, the MAC layer starts the DRX timer corresponding to the MBS multicast session. Optionally, the MAC layer indicates to the upper layer (i.e., the RRC layer) that the MBS multicast session is activated, and the upper layer resumes an MRB corresponding to the MBS multicast session after receiving the indication.

If the base station employs a MAC CE to notify the UE that the MBS multicast session is deactivated, the MAC layer stops the DRX timer corresponding to the MBS multicast session. Optionally, the MAC layer indicates to the upper layer (i.e., the RRC layer) that the MBS multicast session is deactivated, and the upper layer suspends an MRB corresponding to the MBS multicast session after receiving the indication.

If the RRC release message does not indicate the mapping between a TMGI and a G-RNTI, when the UE receives an RRC release message that includes the MAC-CellGroupConfig field, how to process the MAC entity is a problem to be solved.

The following embodiments are provided to solve this problem.

A UE receives an RRC release message from a base station. If the RRC release message includes a suspendConfig field but does not include a MAC-CellGroupConfig field (the MAC-CellGroupConfig field may be included in the suspendConfig field), MAC is reset; or otherwise (i.e., the RRC release message includes a suspendConfig field and a MAC-CellGroupConfig field), the MAC-CellGroupConfig field is applied. The result of applying the MAC-CellGroupConfig field is that the UE stops all timers except a DRX timer for MBS broadcast and DRX timers corresponding to a G-RNTI and/or a G-CS-RNTI configured in the MAC-CellGroupConfig field; or the result of applying the MAC-CellGroupConfig field is that the UE stops all timers except a DRX timer for MBS broadcast, and the UE starts DRX timers corresponding to a G-RNTI and/or a G-CS-RNTI configured in the MAC-CellGroupConfig field.

In the present disclosure, “an MBS multicast session is activated” means that the MBS multicast session is ongoing, and the UE needs to/can receive the MBS multicast session or monitor a corresponding G-RNTI and/or G-CS-RNTI; and “an MBS multicast session is deactivated” means that the MBS multicast session is not ongoing yet, and the UE (temporarily) does not need to receive the MBS multicast session or stop monitoring a corresponding G-RNTI and/or G-CS-RNTI.

It should be noted that, in the embodiments of the present disclosure, an MBS session to be received in RRC_INACTIVE also supports a G-CS-RNTI. Otherwise, the mapping between the TMGI and the G-CS-RNTI is not defined in the embodiments of the present disclosure. In addition, the description of the functions of the fields involved in the present disclosure is applicable to all embodiments of the present disclosure unless otherwise specified.

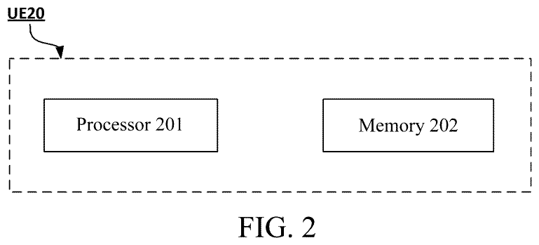

FIG. 2 is a simplified structural block diagram showing a user equipment according to the present invention.

As shown in FIG. 2, the user equipment 20 includes at least a processor 201 and a memory 202. The processor 201 may include, e.g., a microprocessor, a microcontroller, an embedded processor, etc. The memory 202 may include, e.g., a volatile memory (e.g., a random access memory RAM), a hard disk drive (HDD), a non-volatile memory (e.g., a flash memory), or other memory systems. The memory 202 has program instructions stored thereon. When the instructions are run by the processor 201, one or several steps in the processing method for a UE of the present disclosure may be executed.

In the embodiments of the present disclosure, in a case where a plurality of operations are included, the execution order of these operations is exemplarily listed herein. Embodiments derived from altering the execution order of the operations also fall within the scope of protection of the present disclosure.

Additionally, the computer-executable instructions or program running on the device according to the present invention may be a program that enables a computer to implement the functions of the embodiments of the present invention by controlling a central processing unit (CPU). The program or information processed by the program may be temporarily stored in a volatile memory (e.g., a random access memory RAM), a hard disk drive (HDD), a non-volatile memory (e.g., a flash memory), or other memory systems.

The computer-executable instructions or program for implementing the functions of the embodiments of the present invention may be recorded on a computer-readable storage medium. The corresponding functions may be achieved by causing a computer system to read programs recorded on the recording medium and executing the programs. The so-called “computer system” may be a computer system embedded in the device, which may include operating systems or hardware (e.g., peripherals). The “computer-readable storage medium” may be a semiconductor recording medium, an optical recording medium, a magnetic recording medium, a short-time dynamic memory program recording medium, or any other recording medium readable by a computer.

Various features or functional modules of the device used in the above embodiments may be implemented or executed by means of circuits (e.g., monolithic or multi-chip integrated circuits). Circuits designed to execute the functions described in the present specification may include general-purpose processors, digital signal processors (DSPs), application specific integrated circuits (ASICs), field programmable gate arrays (FPGAs) or other programmable logic devices, discrete gates or transistor logic, or discrete hardware components, or any combination of the above. The general-purpose processor may be a microprocessor, or may be any existing processor, controller, microcontroller, or state machine. The circuit may be a digital circuit or an analog circuit. When new integrated circuit technologies that replace existing integrated circuits emerge because of advances in semiconductor technology, one or a plurality of embodiments of the present invention may also be implemented using these new integrated circuit technologies.

Furthermore, the present invention is not limited to the embodiments described above. Although various examples of the embodiments have been described, the present invention is not limited thereto. Fixed or non-mobile electronic devices installed indoors or outdoors, such as AV devices, kitchen devices, cleaning devices, air conditioners, office devices, vending machines, and other household appliances, may be used as terminal devices or communications devices.

The embodiments of the present invention have been described in detail above with reference to the accompanying drawings. However, the specific structures are not limited to the above embodiments. The present invention also includes any design modifications that do not depart from the main idea of the present invention. In addition, various modifications can be made to the present invention within the scope of the claims. Embodiments resulting from appropriate combination of the technical means disclosed in the different embodiments are also included within the technical scope of the present invention. In addition, components with the same effect described in the above embodiments may be replaced with one another.

1. A User Equipment (UE), comprising a processor configured to:
receive an Radio Resource Control (RRC) Release message, is used to configure a Multicast/Broadcast Services (MBS) multicast session to be received in RRC_INACTIVE,
wherein the RRCRelease message includes a configuration of the MBS multicast session, and
wherein the RRCRelease message indicates a mapping between a Temporary Mobile Group Identity (TMGI) and a Group Radio Network Temporary Identifier (G-RNTI) for the MBS multicast session.

2. The UE according to claim 1,
wherein the processor is configured not to monitor
the G-RNTI of the MBS multicast session which is indicated to stop monitoring the G-RNTI in the RRCRelease message.

3. The UE according to claim 1,
wherein the processor is configured to monitor
the G-RNTI of the MBS multicast session which is not indicated to stop monitoring the G-RNTI in the RRCRelease message.

4. A method executed by a user equipment (UE), comprising:
receiving a Radio Resource Control (RRC) Release message, is used to configure a Multicast/Broadcast Services (MBS) multicast session to be received in RRC_INACTIVE,
wherein the RRCRelease message includes a configuration of the MBS multicast session, and
wherein the RRCRelease message indicates a mapping between a Temporary Mobile Group Identity (TMGI) and a Group Radio Network Temporary Identifier (G-RNTI) for the MBS multicast session.

5-6. (canceled)

7. A Base station apparatus, comprising a processor configured to:
transmit a Radio Resource Control (RRC)Release message used to configure a Multicast/Broadcast Services (MBS) multicast session to be received in RRC_INACTIVE by User Equipment (UE),
wherein the RRCRelease message includes a configuration of the MBS multicast session, and
wherein the RRCRelease message indicates a mapping between a Temporary Mobile Group Identity (TMGI) and a Group Radio Network Temporary Identifier (G-RNTI) for the MBS multicast session.
